(19) United States
(12) Patent Application Publication
(10) Pub. No.: US 2019/0362335 A1
(43) Pub. Date: Nov. 28, 2019

(54) IN-VEHICLE DEVICE FOR SECURELY CONDUCTING A TRANSACTION DIRECTLY FROM THE VEHICLE

(71) Applicant: Capital One Services, LLC, McLean, VA (US)

(72) Inventors: Michael J. ROSNER, Richmond, VA (US); Mark ANDERSON, McLean, VA (US)

(21) Appl. No.: 15/994,800

(22) Filed: May 31, 2018

Related U.S. Application Data
(63) Continuation of application No. 15/990,425, filed on May 25, 2018.

(51) Int. Cl. G06Q 20/32; G06Q 20/42; G06Q 30/06; G06Q 30/02; H04W 4/40

(52) U.S. Cl. CPC G06Q 20/3227; G06Q 20/3224; G06Q 20/325; H04W 4/40; G06Q 30/0603; G06Q 30/0281; G06Q 20/425

(57) ABSTRACT

A device, integrated within a vehicle, generates a signal identifying the device and a vehicle, and establishes, via a first network, communications with a merchant device in a vicinity of the vehicle. The device provides, to the merchant device, vehicle information identifying properties of the vehicle, and receives, from the merchant device, merchant information indicating goods or services available from a merchant. The device provides, to the merchant device, order information indicating an order of a particular good or service of the goods or services, and receives, from the merchant device, payment information indicating a price for the particular good or service. The device establishes, via a second network, communications with a transaction device, and provides, to the transaction device, transaction information to be used to pay the price. The device receives, from the merchant device, information confirming payment of the price and confirming the order.

### RELATED APPLICATION

This application is a continuation of U.S. patent application Ser. No. 15/990,425, filed on May 25, 2018, the content of which is incorporated by reference herein in its entirety.

### BACKGROUND

Technologies such as mobile wallets, on-demand applications, and enhanced connectivity through BLUETOOTH® and near-field communications have transformed the way consumers interact and rely on mobile devices, such as smartphones. Functionalities of mobile devices are increasingly being integrated into vehicle infotainment systems. In-vehicle payment via mobile devices is one such functionality. For example, a vehicle infotainment system may include an in-vehicle payment application that enables the vehicle to select how much fuel is required from a service station and to pay using a payment mechanism (e.g., PAYPAL® or APPLE PAY®).

### SUMMARY

According to some implementations, a device may include one or more memories, and one or more processors configured to generate a signal identifying the device and a vehicle, where the device is integrated within the vehicle, and establish, via a first network and based on the signal, communications with a merchant device in a vicinity of the vehicle, where the first network may include an unsecure network. The one or more processors may provide, via the first network and to the merchant device, vehicle information identifying properties of the vehicle, and may receive, based on the vehicle information, via the first network, and from the merchant device, merchant information indicating goods or services available from a merchant associated with the merchant device. The one or more processors may provide, via the first network and to the merchant device, order information indicating an order of a particular good or service of the goods or services, and may receive, via the first network and from the merchant device, payment information indicating a price for the particular good or service. The one or more processors may establish, via a second network that is a secure network, communications with a transaction device, and may provide, via the second network and to the transaction device, transaction information to be used to pay the price for the particular good or service. The one or more processors may receive, based on the vehicle information, via the first network, and from the merchant device, information confirming payment of the price for the particular good or service, and information confirming the order of the particular good or service.

According to some implementations, a non-transitory computer-readable medium may store instructions that include one or more instructions that, when executed by one or more processors of a device, cause the one or more processors to generate a signal identifying the device and a vehicle, where the device is integrated within the vehicle, and establish, via an unsecure network and based on the signal, communications with a merchant device in a vicinity of the vehicle. The one or more instructions may cause the one or more processors to provide, via the unsecure network and to the merchant device, vehicle information identifying properties of the vehicle, and receive, based on the vehicle information, via the unsecure network, and from the merchant device, merchant information indicating items available from a merchant associated with the merchant device. The one or more instructions may cause the one or more processors to provide, via the unsecure network and to the merchant device, order information indicating an order of a particular item of the items, and receive, via the unsecure network and from the merchant device, payment information indicating a price for the particular item. The one or more instructions may cause the one or more processors to establish, via a secure network, secure communications with a transaction device, and provide, via the secure network and to the transaction device, transaction information to be used to pay the price for the particular good or service, where the transaction information includes information identifying a transaction account associated with a user of the device. The one or more instructions may cause the one or more processors to receive, via the secure network and from the transaction device, information confirming payment of the price for the particular item, and receive, based on the vehicle information, via the unsecure network, and from the merchant device, information confirming the order of the particular item.

According to some implementations, a method may include generating, by a device, a signal identifying the device and a vehicle, where the device is integrated within the vehicle, and establishing, by the device, based on the signal, and via a first network, communications with a merchant device in a vicinity of the vehicle, where the first network may include an unsecure network. The method may include providing, by the device, via the first network, and to the merchant device, vehicle information identifying properties of the vehicle, and receiving, by the device, based on the vehicle information, via the first network, and from the merchant device, merchant information indicating goods or services available from a merchant associated with the merchant device. The method may include providing, by the device, via the first network, and to the merchant device, order information indicating an order of a particular good or service of the goods or services, and receiving, by the device, based on the vehicle information, via the first network, and from the merchant device, payment information indicating a price for the particular good or service. The method may include establishing, by the device and via a second network that is a secure network, communications with a transaction device, and providing, by the device, via the second network, and to the transaction device, transaction information to be used to pay the price for the particular good or service. The method may include receiving, by the device, via the second network, and from the transaction device, information confirming payment of the price for the particular good or service, and receiving, by the device, based on the vehicle information, via the first network, and from the merchant device, information confirming the order of the particular good or service.

### BRIEF DESCRIPTION OF THE DRAWINGS

FIGS. 1A-1G are diagrams of an overview of an example implementation described herein.

FIGS. 2A-2G are diagrams of an overview of an example implementation described herein.

FIG. 3 is a diagram of an example environment in which systems and/or methods, described herein, may be implemented.

FIG. 4 is a diagram of example components of one or more devices of FIG. 2.

FIG. 5 is a flow chart of an example process for securely conducting a transaction with a user device provided in a vehicle.

FIG. 6 is a flow chart of an example process for securely conducting a transaction with a device integrated within a vehicle.

### DETAILED DESCRIPTION

The following detailed description of example implementations refers to the accompanying drawings. The same reference numbers in different drawings may identify the same or similar elements.

In-vehicle payment applications are limited to specific merchants associated with the in-vehicle payment applications. Thus, a vehicle with in-vehicle payment applications may only utilize the specific merchants to purchase goods and/or services. Furthermore, the in-vehicle payment applications utilize the unsecure networks of the specific merchants to purchase the goods and/or services during transaction. The unsecure networks are susceptible to theft of transaction information, such as a transaction card number or a transaction account number associated with a user of the in-vehicle payment applications.

Some implementations described herein enable a user device, provided in a vehicle, to securely conduct a transaction. For example, the user device may establish communications with a merchant device in a vicinity of the vehicle, and may receive, from the merchant device, information indicating goods and/or services available from a merchant associated with the merchant device. The communications with the merchant device may be via short range communication protocols (e.g., via wireless beacons, etc.). Such short range protocols provide advantages based on a proximity between a vehicle and a merchant device. Such protocols, however, may not be secure enough to enable transmission of certain information (e.g., payment or transaction information) that may be helpful to enable transactions between customers and merchants. Throughout this disclosure, such protocols may generally be referred to as unsecure networks. The user device may provide, via the unsecure network and to the merchant device, information indicating an order of a particular good or service, and may receive, via the unsecure network and from the merchant device, information indicating a price for the particular good or service. The user device may establish, via a secure network, communications with a transaction device, and may provide, via the secure network and to the transaction device, transaction information to be used to pay the price for the particular good or service. The user device may receive, via the unsecure network and from the merchant device, information confirming payment of the price and confirming the order of the particular good or service.

Some implementations described herein enable a device integrated within a vehicle to securely conduct a transaction. For example, the vehicle-integrated device may generate a signal identifying the vehicle-integrated device and the vehicle, and may establish, via an unsecure network and based on the signal, communications with a merchant device in a vicinity of the vehicle. The vehicle-integrated device may receive, via the first network and from the merchant device, merchant information indicating goods or services available from a merchant associated with the merchant device, and may provide, via the first network and to the merchant device, order information indicating an order of a particular good or service. The vehicle-integrated device may receive, via the first network and from the merchant device, payment information indicating a price for the particular good or service, and may establish, via a second network, communications with a transaction device. The vehicle-integrated device may provide, via the second network and to the transaction device, transaction information to be used to pay the price for the particular good or service, and may receive, via the first network and from the merchant device, information confirming payment of the price and confirming the order of the particular good or service.

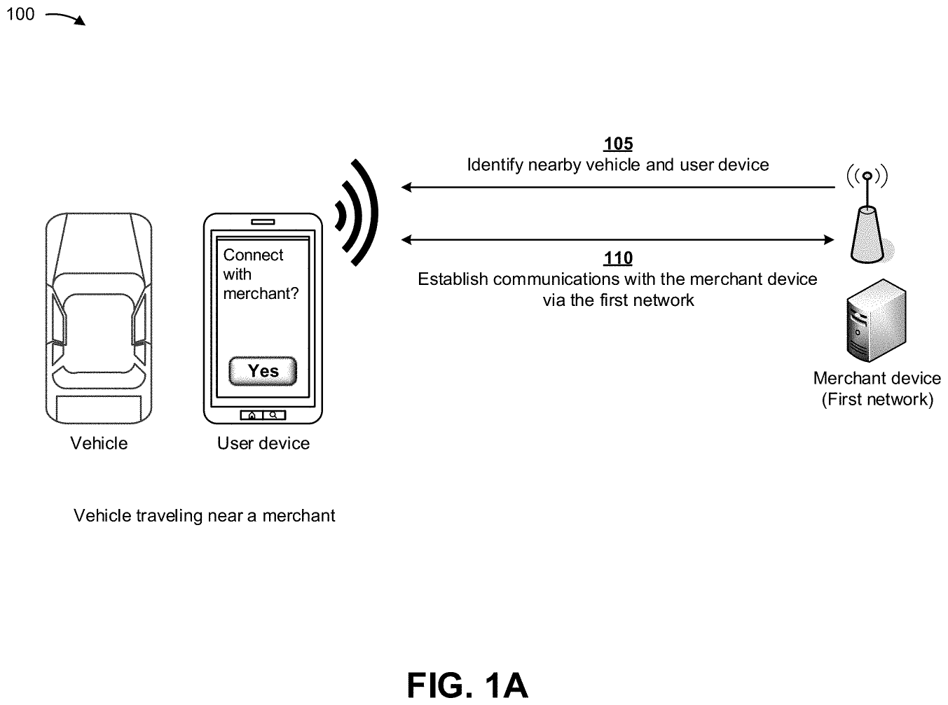

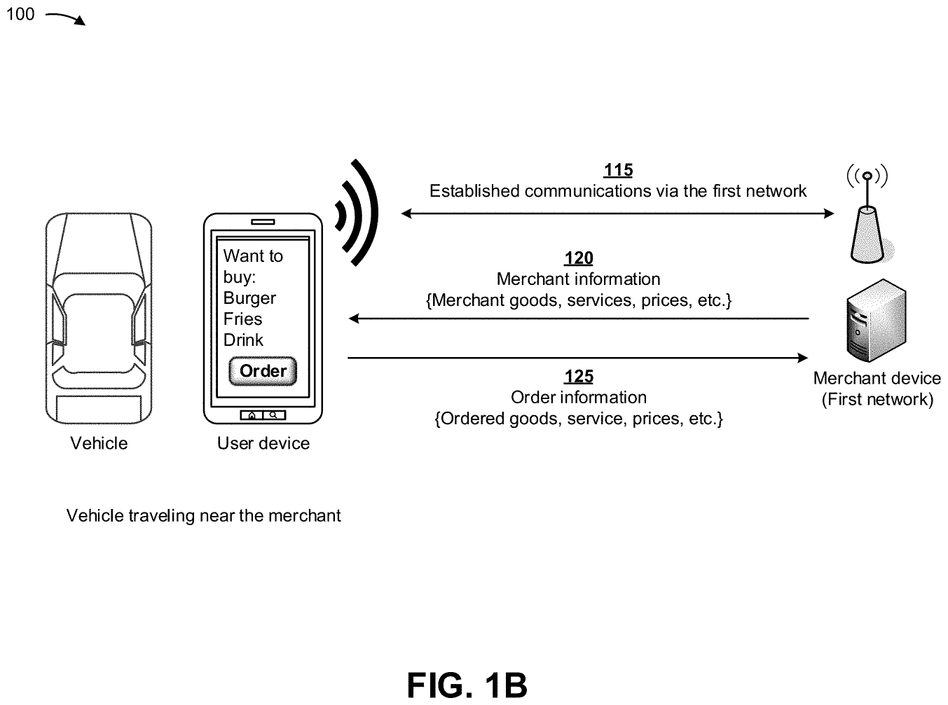

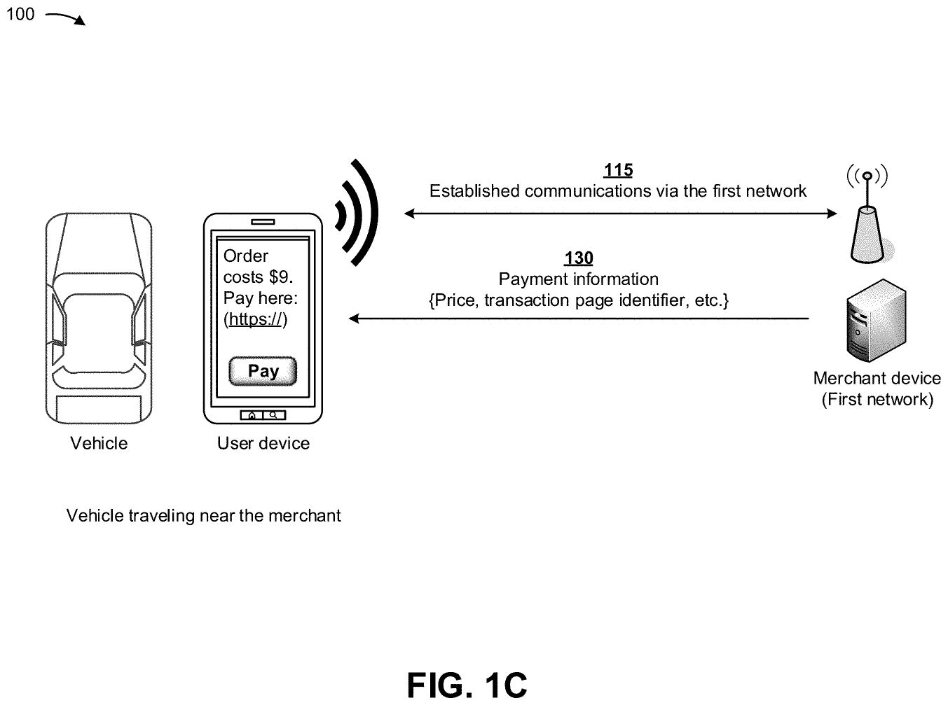

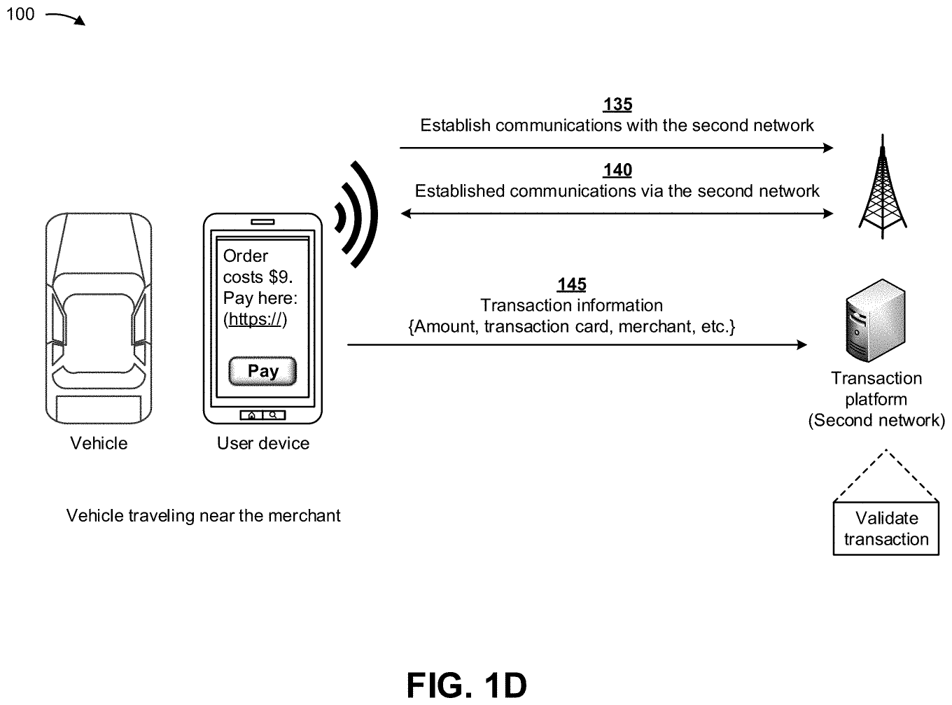

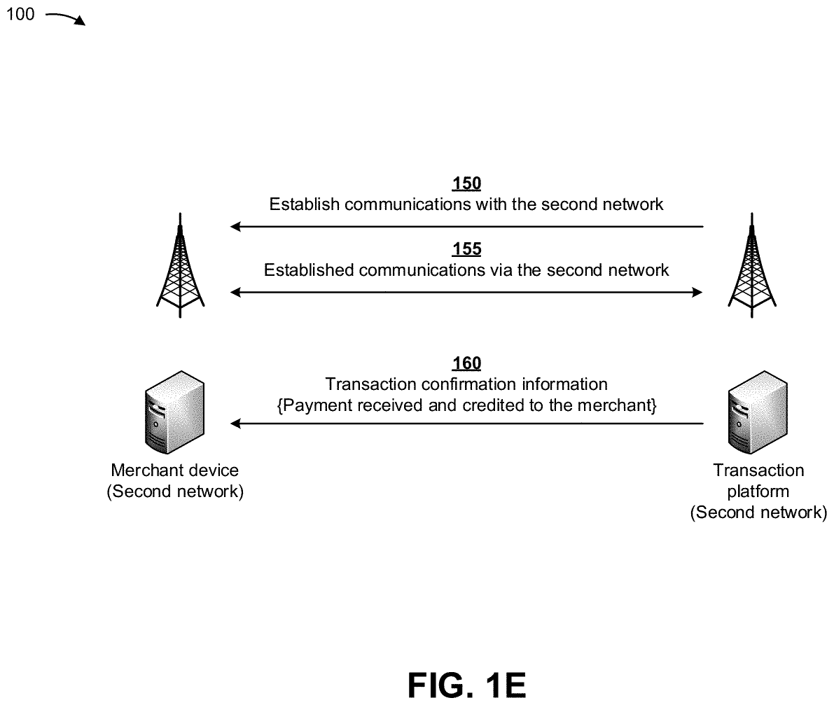

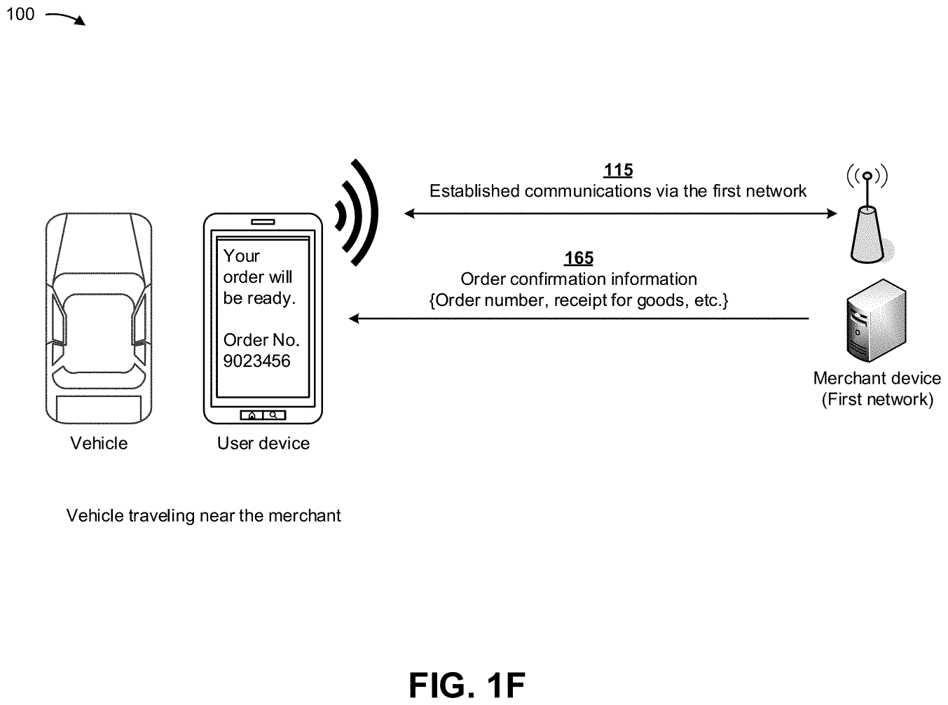

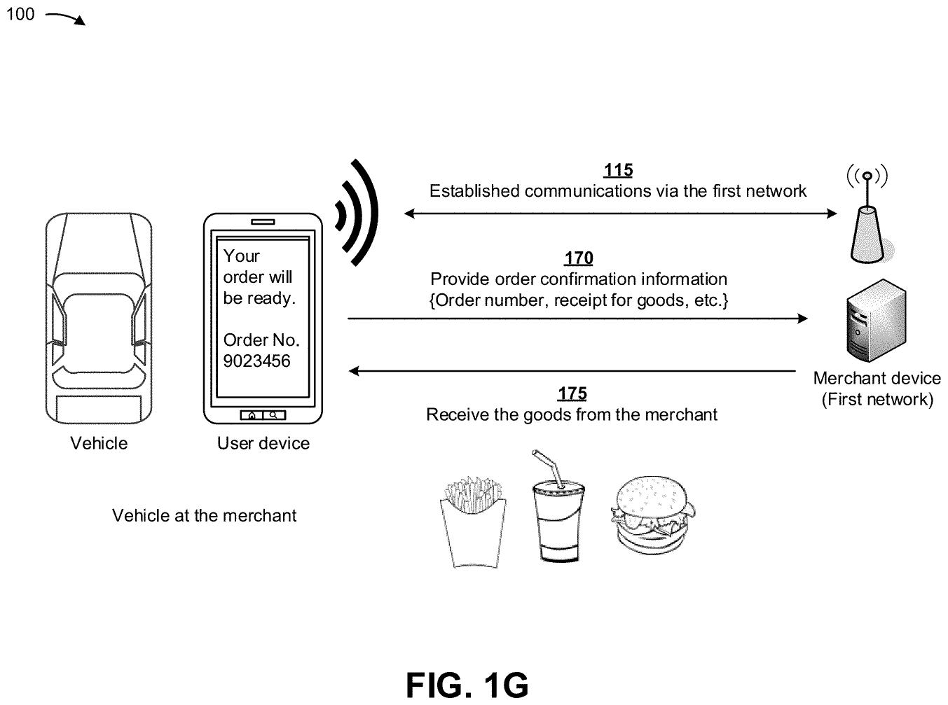

FIGS. 1A-1G are diagrams of an overview of an example implementation 100 described herein. As shown in FIG. 1A, an example system may include a user device that may be associated with a vehicle, a merchant device, and a first network associated with the merchant device. As further shown, the vehicle and the user device may be traveling near a merchant associated with the merchant device. For example, the vehicle may be traveling near a building operated by the merchant and in which the merchant device is located. The merchant device may include or be associated with a beacon that establishes the first network. In some implementations, the merchant device may utilize the first network to identify nearby vehicles and/or user devices. In some implementations, the user device may be utilized by a user physically present at a merchant store or a user associated with a vehicle. In such implementations, the merchant device may detect a particular location of the user (e.g., in association with a particular vehicle or physically present in the store), the user may provide a vehicle descriptor, a table number, and/or the like to the merchant device.

In some implementations, the first network may include an unsecure wireless network, such as a BLUETOOTH® technology-based network (e.g., including a BLUETOOTH® Low Energy (BLE) technology-based network), a Wi-Fi technology-based network, an infrared technology-based network, a near field communication (NFC) technology-based network, an ultraband technology-based network, a ZIGBEE® technology-based network, combinations of the aforementioned networks, and/or the like. In some implementations, the user device may broadcast a signal identifying the vehicle and/or the user device, and the merchant device may identify the vehicle and/or the user device based on the signal when the vehicle and/or the user device are within a range of the first network.

As further shown in FIG. 1A, and by reference number 105, assume that the merchant device identifies the vehicle and/or the user device, based on the signal and via the first network. As further shown in FIG. 1A, and by reference number 110, the user device may establish communications with the merchant device, via the first network. In some implementations, the user device may provide, for display, a user interface that requests whether a user of the user device wishes to connect with the merchant (e.g., the merchant device). In such implementations, if the user wishes to connect with the merchant device, the user may utilize the user interface to indicate that the user device is to connect with the merchant device. This indication by the user may cause the user device to establish communications with the merchant device via the first network.

As shown in FIG. 1B, and by reference number 115, after the user device establishes communications with the merchant device, the user device and the merchant device may have established unsecure communications, via the first network. As further shown in FIG. 1B, and by reference number 120, after the communications are established between the user device and the merchant device, the merchant device may provide merchant information to the user device, and the user device may receive the merchant information. In some implementations, the merchant information may include information identifying goods sold by the merchant, services offered by the merchant, prices associated with the goods, prices associated with the services, promotions offered by the merchant, and/or the like. For example, if the merchant is a fast food restaurant, the merchant information may include information identifying food (e.g., burgers, fries, chicken sandwiches, etc.) offered by the merchant, drinks (e.g., sodas, milkshakes, water, etc.) offered by the merchant, prices associated with the food and the drinks, and/or the like.

As further shown in FIG. 1B, the user device may provide the merchant information for display via a user interface, and the user may select goods and/or services from the merchant information, via the user interface. For example, the user may select a burger, fries, and a drink from the merchant information when the merchant is a fast food restaurant. As further shown in FIG. 1B, and by reference number 125, after the user selects the goods and/or services from the merchant information, the user may cause the user device to provide order information to the merchant device, via the first network. The merchant device may receive the order information from the user device. In some implementations, the order information may include information identifying one or more goods selected by the user, one or more services selected by the user, prices associated with the selected goods and/or services, and/or the like.

As shown in FIG. 1C, and by reference number 130, the user device may receive, via the first network and from the merchant device, payment information associated with the one or more goods and/or services ordered by the user. In some implementations, the merchant device may provide the payment information to the user device based on receiving the order information from the user device. In some implementations, the payment information may include information identifying the merchant device, the merchant, the user device, the user, a vehicle identifier associated with the user or user device, a price for the order, a secure transaction page (e.g., a link, a secure uniform resource locator (URL), a secure web page, and/or the like) for completing a transaction for the order, and/or the like. In some implementations, the secure transaction page may include information identifying a location of a secure transaction platform (e.g., https://location_identifier).

As further shown in FIG. 1C, the user device may provide the payment information for display to the user via a user interface. For example, the user interface may indicate that the order costs a price of $9.00 and that payment is to be made via a secure URL (e.g., https://). The URL may be unique to a particular customer and a particular order. The user interface may include a mechanism (e.g., a “Pay” button, icon, hyperlink, and/or the like) that, when selected, causes the user device to begin the transaction process for the order. In some implementations, when the mechanism is selected, the user device may access the secure URL in order to begin the transaction process for the particular order that may be associated with the URL.

Instead of utilizing the unsecure network (e.g., the first network) to conduct the transaction process (e.g., by providing transaction information to the merchant device via the first network), implementations described herein may enable the user device to conduct the transaction process directly with a transaction platform via a secure network. In this way, the user device may securely provide transaction information to the transaction platform, via the secure network and without the potential for the transaction information being compromised.

As shown in FIG. 1D, and by reference number 135, when the user device accesses the secure URL, the user device may establish secure communications with the transaction platform (e.g., associated with the secure URL), via a second network associated with the transaction platform. In some implementations, the second network may include a secure network that is separate from the first network. For example, the second network may include a cellular network, a public land mobile network (PLMN), a local area network (LAN), a wide area network (WAN), a metropolitan area network (MAN), a wireless network, combinations of the aforementioned networks, and/or the like.

As further shown in FIG. 1D, and by reference number 140, after the user device establishes communications with the transaction platform, the user device and the transaction platform may securely communicate via the second network. In some implementations, the second network may utilize one or more encryption techniques to encrypt and provide secure communications between the user device and the transaction platform. In some implementations, the one or more encryption techniques may include a Rivest-Shamir-Adleman (RSA) encryption technique, a Diffie-Hellman encryption technique, a digital signature algorithm (DSA) encryption technique, an ElGamal encryption technique, an elliptic-curve cryptography (ECC) encryption technique, an elliptic curve digital signature algorithm (ECDSA) encryption technique, an efficient and compact subgroup trace representation (XTR) encryption technique, and/or the like.

The RSA encryption technique may include a type of public-key cryptosystem. A public-key cryptosystem employs a public encryption key (e.g., an encryption key that can be used by anyone) to encrypt the data, and employs a private decryption key (e.g., a decryption key that is kept secret) such that only someone who has the private key can decrypt the data. In some implementations, a user of the RSA encryption technique may create and then publish a public key based on two large prime numbers, along with an auxiliary value. The prime numbers are kept secret. Anyone can use the public key to encrypt a message, but (with currently published methods) if the public key is large enough, only someone with knowledge of the prime numbers can decode the message.

The Diffie-Hellman encryption technique may include a method of securely exchanging cryptographic keys in which two parties that have no prior knowledge of each other can jointly establish a shared secret key over an insecure channel, and the key can then be used to encrypt subsequent communications using a symmetric key cipher. For example, in a Diffie-Hellman key encryption technique, each party may generate a public/private key pair and distribute the public key. After obtaining an authentic copy of each of the public keys, the parties can compute a shared secret offline. The shared secret can be used, for instance, as the key for a symmetric cipher.

The DSA encryption technique may utilize the Federal Information Processing Standard (FIPS) for digital signatures. The DSA encryption technique may be used by a signatory to generate a digital signature on data and by a verifier to verify an authenticity of the signature. In this case, each signatory may have a public key and a private key. The private key is used in the signature generation process and the public key is used in the signature verification process. For both signature generation and signature verification, the data (i.e., a message) is reduced by means of a secure hash algorithm (e.g., the Secure Hash Algorithm (SHA) specified in FIPS 180-1). An adversary, who does not know the private key of the signatory, cannot generate the correct signature of the signatory. However, by using the signatory's public key, anyone can verify a correctly signed message.

The ElGamal encryption technique may include an asymmetric key encryption technique for public-key cryptography that is based on the Diffie-Hellman encryption technique. The ElGamal encryption technique may provide an additional layer of security by asymmetrically encrypting keys previously used for symmetric message encryption.

The ECC encryption technique may include a form of public-key cryptography based on an algebraic structure of elliptic curves over finite fields. For elliptic curve-based protocols, finding a discrete logarithm of a random elliptic curve element with respect to a publicly known base point is assumed to be infeasible. This is known as the elliptic curve discrete logarithm problem (ECDLP). The security of elliptic curve cryptography depends on the ability to compute a point multiplication and the inability to compute a multiplicand given an original and product points. The ECC encryption technique may require smaller keys compared to non-ECC cryptography to provide equivalent security.

The ECDSA encryption technique may include a technique that is a variant of the DSA encryption technique and that employs the ECC encryption technique. The ECDSA encryption technique utilizes a discrete logarithm problem of classical computers for computation hardness.

The XTR encryption technique may include a technique that makes use of traces to represent and calculate powers of elements of a subgroup of a finite field. For example, the XTR encryption technique may include an algorithm for public-key encryption that represents elements of a subgroup of a multiplicative group of a finite field. Unlike many cryptographic protocols that are based on a generator of a full multiplicative group of a finite field, the XTR encryption technique uses a generator of a relatively small subgroup of some prime order of a subgroup. From a security point of view, the XTR encryption technique relies on the difficulty of solving discrete logarithm related problems in a multiplicative group of a finite field.

In this way, the transaction platform may utilize one or more of the aforementioned encryption techniques to provide secure communications between the user device and the transaction platform. In some implementations, the transaction platform may select which one or more of the encryption techniques to utilize based on an amount of the transaction, preferences provided by the user of the user device, preferences provided by the merchant, and/or the like.

As further shown in FIG. 1D, and by reference number 145, after the secure communications are established between the user device and the transaction platform, the user device may securely provide, via the second network and to the transaction platform, transaction information to utilize to pay the price for the order. In some implementations, the transaction information may include information identifying an amount to be paid for the order (e.g., the price of $9.00), a transaction card number (or other account number) associated with the user of the user device and to be utilized to pay for the order, a transaction account associated with the user of the user device and to be utilized to pay for the order, a merchant account associated with the merchant and to which payment is to be provided, a name of the merchant, the goods and/or services associated with order, and/or the like.

In some implementations, the transaction platform may receive the transaction information, and may validate the transaction based on the transaction information. For example, the transaction platform may validate that the user is associated with the transaction card and/or the transaction account, may validate that the transaction card and/or the transaction account contains enough funds to pay for the order, may validate that the merchant account is legitimate, and/or the like. If the transaction platform does not validate the transaction, the transaction platform may deny the transaction and provide, to the user device, information indicating that the transaction is invalid and denied. If the transaction platform validates the transaction, the transaction platform may approve the transaction, may provide, to the user device, information indicating that the transaction is valid and approved, and may credit the merchant account with the amount paid for the order.

As shown in FIG. 1E, and by reference number 150, when the transaction platform validates the transaction, the transaction platform may establish secure communications with the merchant device, via the second network. As further shown in FIG. 1E, and by reference number 155, after the transaction platform establishes communications with the merchant device, the transaction platform and the merchant device may securely communicate via the second network. In some implementations, the second network may utilize the one or more encryption techniques, described elsewhere herein, to encrypt and provide secure communications between the transaction platform and merchant device.

As further shown in FIG. 1E, and by reference number 160, after the secure communications are established between the transaction platform and the merchant device, the transaction platform may securely provide, via the second network and to the merchant device, transaction confirmation information (e.g., via an application programming interface (API) posted directly to a merchant's in-store ordering queue, ordering system, and/or the like. In some implementations, the transaction confirmation information may include information confirming the transaction, information indicating that payment was received for the transaction from the transaction card and/or the transaction account, information indicating that the payment was credited to the merchant account, and/or the like.

As shown in FIG. 1F, and by reference number 165, the user device may receive, via the first network and from the merchant device, order confirmation information. In some implementations, the order confirmation information may include information indicating that payment was received for the order, an order identifier (e.g., an order number, an order code, and/or the like), a receipt for the goods and/or services, and/or the like. As further shown in FIG. 1F, the user device may provide the order confirmation information for display to the user via a user interface. For example, the user interface may include information indicating that the order (e.g., for the burger, the fries, and the drink) will be ready, information indicating an order number (e.g., “9023456”) for the order, and/or the like.

As shown in FIG. 1G, and by reference numbers 170 and 175, the user device may provide, via the first network, the order confirmation information to the merchant device so that the user may receive the goods (e.g., the burger, the fries, and the drink) from the merchant. In some implementations, the user may show the user interface with the order confirmation information to the merchant, and the merchant may provide the goods to the user based on viewing the order confirmation information.

In some implementations, the user device may provide, to the merchant device, information identifying a make, model, year, color, and/or the like, of the vehicle associated with the user device, information identifying the user of the user device (e.g., an image of the user), information identifying a location associated with the merchant (e.g., a table number) and/or the like. The merchant device may utilize such information to automatically deliver the goods to the vehicle. For example, the merchant device may dispatch a drone, a robot, and/or the like to identify the vehicle and/or the user, and deliver the goods to the vehicle and/or the user. In some implementations, the user device may provide, to the merchant device, location information associated with the user device, and the drone, the robot, and/or the like, may utilize the location information to deliver the goods to the vehicle and/or the user.

In this way, several different stages of the process for securely conducting a transaction with a user device provided in a vehicle are automated, which may remove human subjectivity and waste from the process, and which may improve speed and efficiency of the process and conserve computing resources (e.g., processing resources, memory resources, and/or the like). Furthermore, implementations described herein use a rigorous, computerized process to perform tasks or roles that were not previously performed or were previously performed using subjective human intuition or input. For example, currently there does not exist a technique to securely conduct a transaction with a user device provided in a vehicle. Finally, automating the process for securely conducting a transaction with a user device provided in a vehicle conserves computing resources (e.g., processing resources, memory resources, and/or the like) that would otherwise be wasted in attempting to securely conduct a transaction with a user device provided in a vehicle.

As indicated above, FIGS. 1A-1G are provided merely as examples. Other examples are possible and may differ from what was described with regard to FIGS. 1A-1G.

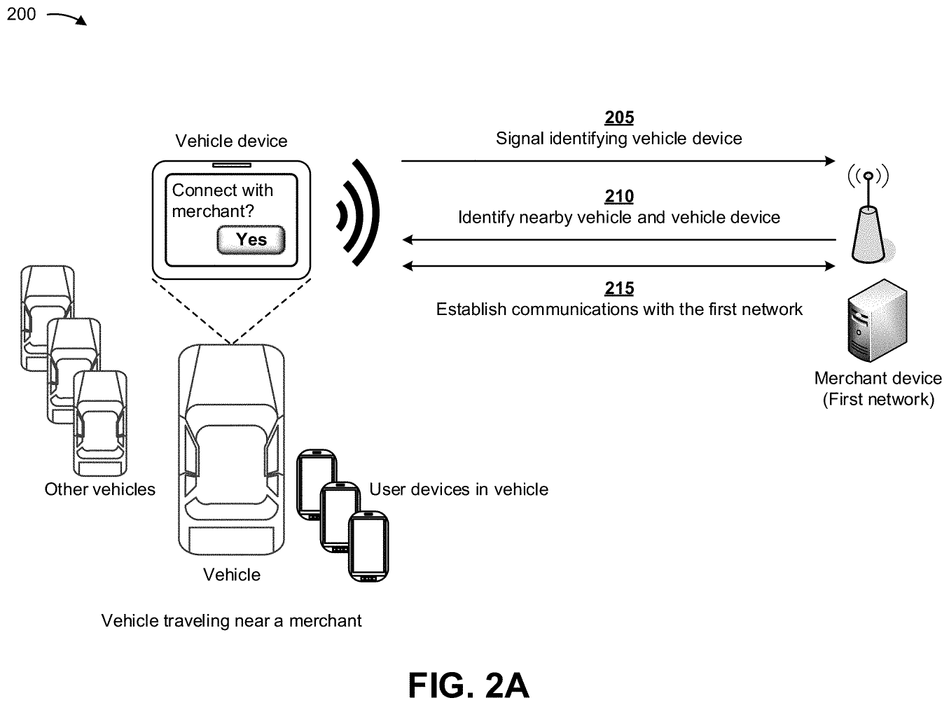

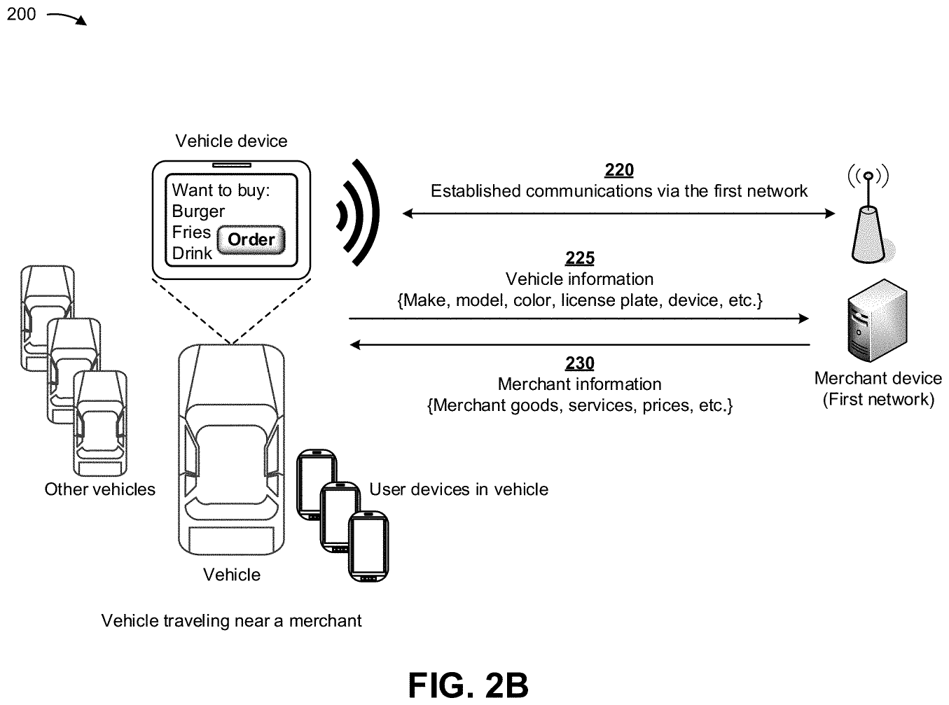

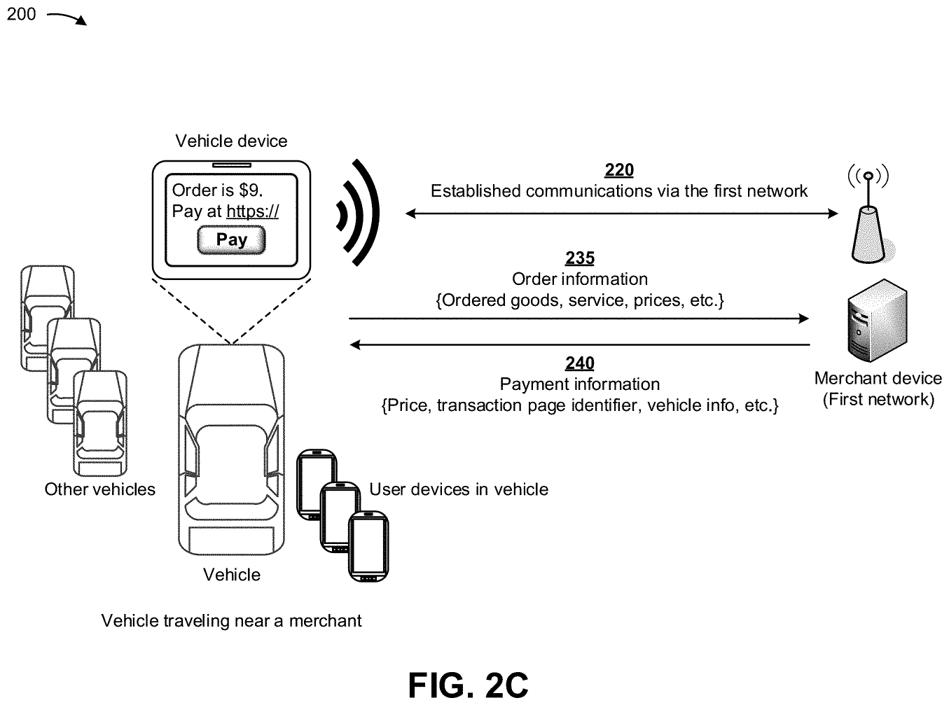

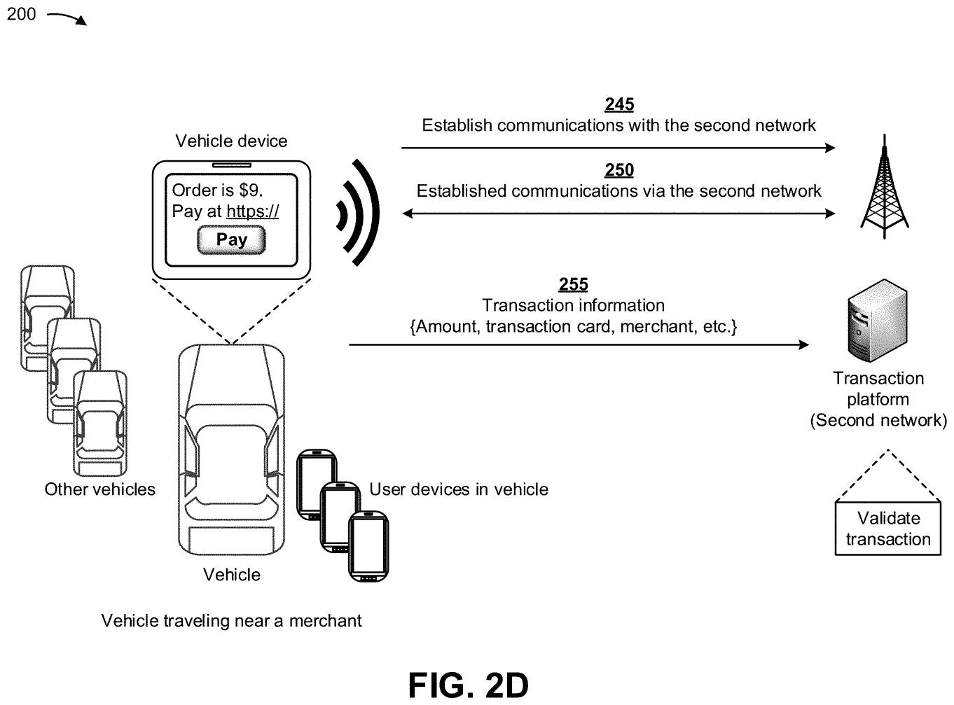

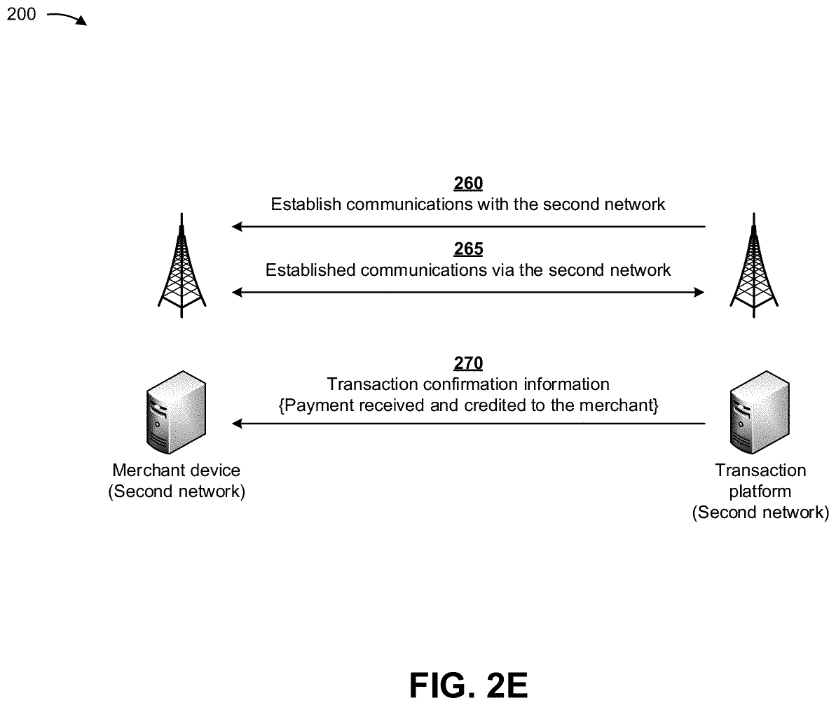

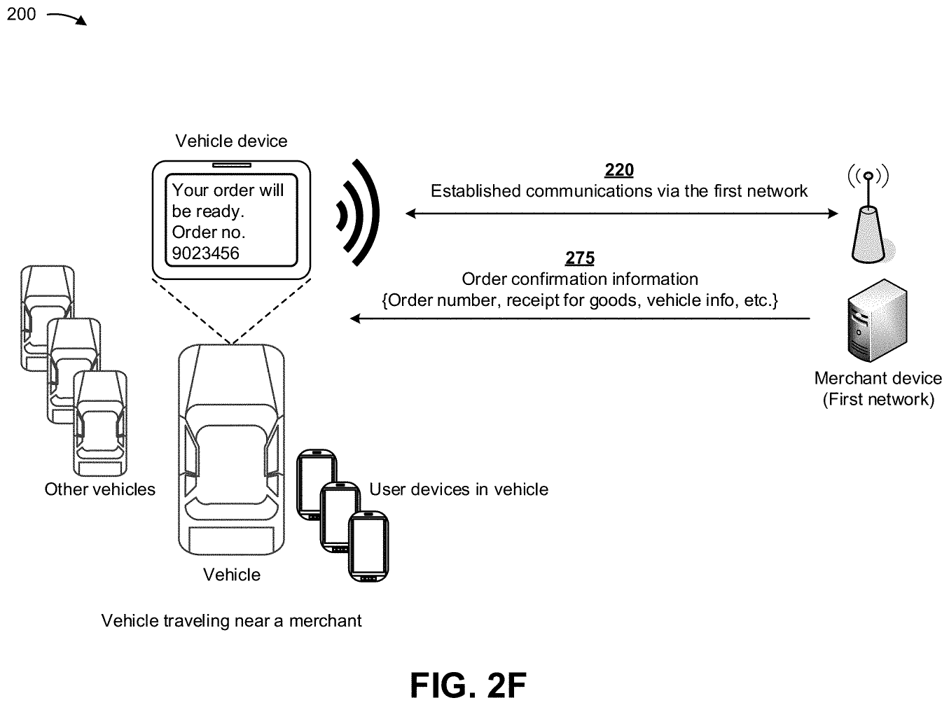

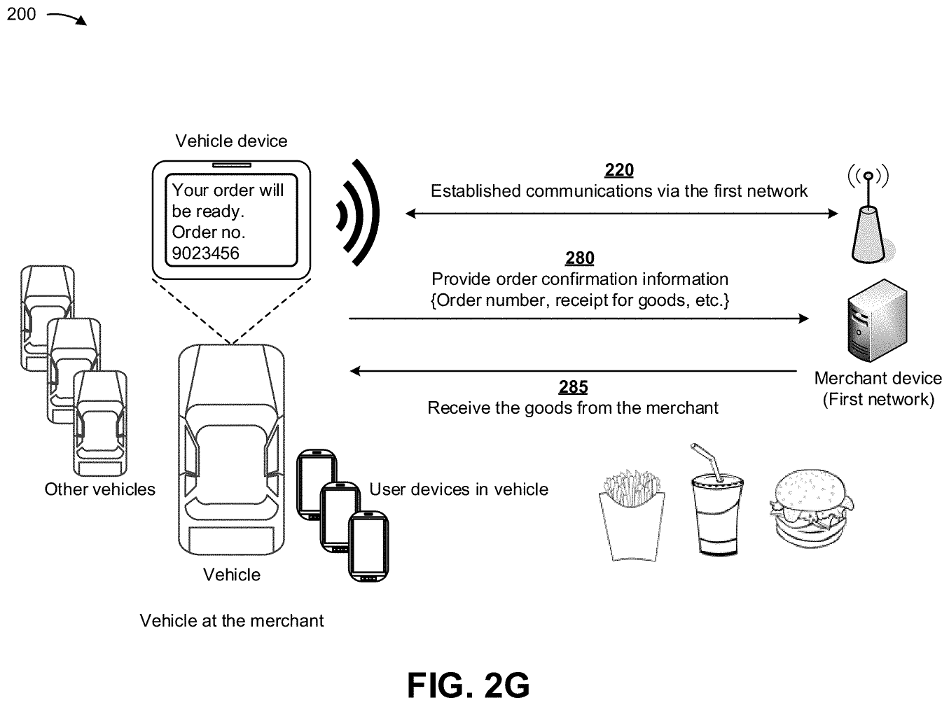

FIGS. 2A-2G are diagrams of an overview of an example implementation 200 described herein. As shown in FIG. 2A, a vehicle device, integrated within a vehicle, may be associated with a merchant device and a first network associated with the merchant device. As further shown, the vehicle and the vehicle device may be traveling near a merchant associated with the merchant device. For example, the vehicle may be traveling near a building operated by the merchant and in which the merchant device is located. The merchant device may include or be associated with a beacon that establishes the first network.

In some implementations, the first network may include an unsecure wireless network, such as a BLUETOOTH® technology-based network (e.g., including a BLUETOOTH® Low Energy (BLE) technology-based network), a Wi-Fi technology-based network, an infrared technology-based network, a near field communication (NFC) technology-based network, an ultraband technology-based network, a ZIGBEE® technology-based network, combinations of the aforementioned networks, and/or the like. In some implementations, and as shown by reference number 205, the vehicle device may broadcast a signal identifying the vehicle and/or the vehicle device, and the merchant device may identify the vehicle and/or the vehicle device based on the signal when the vehicle and/or the vehicle device are within a range of the first network.

As further shown in FIG. 2A, and by reference number 210, assume that the merchant device identifies the vehicle and/or the vehicle device, based on the signal and via the first network. As further shown in FIG. 2A, and by reference number 215, the vehicle device may establish communications with the merchant device, via the first network. In some implementations, the vehicle device may provide, for display, a user interface that requests whether a user of the vehicle device wishes to connect with the merchant (e.g., the merchant device). In such implementations, if the user wishes to connect with the merchant device, the user may utilize the user interface to indicate that the vehicle device is to connect with the merchant device. This indication by the user may cause the vehicle device to establish communications with the merchant device via the first network.

As further shown in FIG. 2A, other vehicles may be near the merchant device, and multiple user devices may be provided in the vehicle (e.g., by passengers in the vehicle). In some implementations, the merchant device may utilize the first network to identify the other nearby vehicles and/or the multiple user devices. However, the merchant device may be able to distinguish between the vehicle device, the other vehicles, and the multiple user devices based on the signal identifying the vehicle and/or the vehicle device. In this way, the merchant device may not provide communications intended for the vehicle device, described elsewhere herein, to the multiple user devices in the vehicle and/or to the other vehicles.

As shown in FIG. 2B, and by reference number 220, after the vehicle device establishes communications with the merchant device, the vehicle device and the merchant device may have established unsecure communications, via the first network. As further shown in FIG. 2B, and by reference number 225, after the communications are established between the vehicle device and the merchant device, the vehicle device may provide vehicle information to the merchant device, and the merchant device may receive the vehicle information. In some implementations, the vehicle information may include information identifying the vehicle device, a make of the vehicle, a model of the vehicle, a color of the vehicle, a license plate number of the vehicle, and/or the like. In this way, the merchant device may display the vehicle information to a merchant employee, and the merchant employee may more easily identify where order and/or price information is to be sent (e.g., send to a 1998 red sports car), and the information may be sent to the proper device (e.g., the vehicle device).

As further shown in FIG. 2B, and by reference number 230, after the communications are established between the vehicle device and the merchant device, the merchant device may provide merchant information to the vehicle device, and the vehicle device may receive the merchant information. In some implementations, the merchant information may include information identifying goods sold by the merchant, services offered by the merchant, prices associated with the goods, prices associated with the services, promotions offered by the merchant, and/or the like. For example, if the merchant is a fast food restaurant, the merchant information may include information identifying food (e.g., burgers, fries, chicken sandwiches, etc.) offered by the merchant, drinks (e.g., sodas, milkshakes, water, etc.) offered by the merchant, prices associated with the food and the drinks, and/or the like.

As further shown in FIG. 2B, the vehicle device may provide the merchant information for display via a user interface, and the user may select goods and/or services from the merchant information, via the user interface. For example, the user may select a burger, fries, and a drink from the merchant information when the merchant is a fast food restaurant.

As shown in FIG. 2C, and by reference number 235, after the user selects the goods and/or services from the merchant information, the user may cause the vehicle device to provide order information to the merchant device, via the first network. The merchant device may receive the order information from the vehicle device. In some implementations, the order information may include information identifying one or more goods selected by the user, one or more services selected by the user, prices associated with the selected goods and/or services, and/or the like.

As shown in FIG. 2C, and by reference number 240, the vehicle device may receive, via the first network and from the merchant device, payment information associated with the one or more goods and/or services ordered by the user. In some implementations, the merchant device may provide the payment information to the vehicle device based on receiving the order information from the vehicle device. In some implementations, the payment information may include information identifying the merchant device, the merchant, the vehicle device, the user of the vehicle device, a price for the order, a secure transaction page (e.g., a link, a secure uniform resource locator (URL), a secure web page, and/or the like) for completing a transaction for the order, and/or the like. In some implementations, the secure transaction page may include information identifying a location of a secure transaction platform (e.g., https://location_identifier).

As further shown in FIG. 2C, the vehicle device may provide the payment information for display to the user via a user interface. For example, the user interface may indicate that the order costs a price of $9.00 and that payment is to be made via a secure URL (e.g., https://). The user interface may include a mechanism (e.g., a “Pay” button, icon, hyperlink, and/or the like) that, when selected, causes the vehicle device to begin the transaction process for the order. In some implementations, when the mechanism is selected, the vehicle device may access the secure URL in order to begin the transaction process for the order.

Instead of utilizing the unsecure network (e.g., the first network) to conduct the transaction process (e.g., by providing transaction information to the merchant device via the first network), implementations described herein may enable the vehicle device to conduct the transaction process directly with a transaction platform via a secure network, as described elsewhere herein. In this way, the vehicle device may securely provide transaction information to the transaction platform, via the secure network and without the potential for the transaction information being comprised.

As shown in FIG. 2D, and by reference number 245, when the vehicle device accesses the secure URL, the vehicle device may establish secure communications with the transaction platform (e.g., associated with the secure URL), via a second network associated with the transaction platform. In some implementations, the second network may include a secure network that is separate from the first network. For example, the second network may include a cellular network, a public land mobile network (PLMN), a local area network (LAN), a wide area network (WAN), a metropolitan area network (MAN), a wireless network, combinations of the aforementioned networks, and/or the like.

As further shown in FIG. 2D, and by reference number 250, after the vehicle device establishes communications with the transaction platform, the vehicle device and the transaction platform may securely communicate via the second network. In some implementations, the vehicle device and transaction platform may utilize one or more encryption techniques to encrypt and provide secure communications between the vehicle device and the transaction platform. In some implementations, the one or more encryption techniques may include a Rivest-Shamir-Adleman (RSA) encryption technique, a Diffie-Hellman encryption technique, a digital signature algorithm (DSA) encryption technique, an ElGamal encryption technique, an elliptic-curve cryptography (ECC) encryption technique, an elliptic curve digital signature algorithm (ECDSA) encryption technique, an efficient and compact subgroup trace representation (XTR) encryption technique, and/or the like, as described above.

In this way, the vehicle device and the transaction platform may utilize one or more of the aforementioned encryption techniques to provide secure communications between the vehicle device and the transaction platform. In some implementations, the vehicle device and/or the transaction platform may select which one or more of the encryption techniques to utilize based on an amount of the transaction, preferences provided by the user of the vehicle device, preferences provided by the merchant, and/or the like.

As further shown in FIG. 2D, and by reference number 255, after the secure communications are established between the vehicle device and the transaction platform, the vehicle device may securely provide, via the second network and to the transaction platform, transaction information to utilize to pay for the order. In some implementations, the transaction information may include information identifying an amount to be paid for the order (e.g., the price of $9.00), a transaction card associated with the user of the vehicle device and to be utilized to pay for the order, a transaction account associated with the user of the vehicle device and to be utilized to pay for the order, a merchant account associated with the merchant and to which payment is to be provided, a name of the merchant, the goods and/or services associated with order, and/or the like.

In some implementations, the transaction platform may receive the transaction information, and may validate the transaction based on the transaction information. For example, the transaction platform may validate that the user is associated with the transaction card and/or the transaction account, may validate that the transaction card and/or the transaction account contains enough funds to pay for the order, may validate that the merchant account is legitimate, and/or the like. If the transaction platform does not validate the transaction, the transaction platform may deny the transaction and provide, to the vehicle device, information indicating that the transaction is invalid and denied. If the transaction platform validates the transaction, the transaction platform may approve the transaction, may provide, to the vehicle device, information indicating that the transaction is valid and approved, and may credit the merchant account with the amount to be paid for the order.

As shown in FIG. 2E, and by reference number 260, when the transaction platform validates the transaction, the transaction platform may establish secure communications with the merchant device, via the second network. As further shown in FIG. 2E, and by reference number 265, after the transaction platform establishes communications with the merchant device, the transaction platform and the merchant device may securely communicate via the second network. In some implementations, the transaction platform and the merchant device may utilize the one or more encryption techniques, described elsewhere herein, to encrypt and provide secure communications between the transaction platform and the merchant device.

As further shown in FIG. 2E, and by reference number 270, after the secure communications are established between the transaction platform and the merchant device, the transaction platform may securely provide, via the second network and to the merchant device, transaction confirmation information. In some implementations, the transaction confirmation information may include information confirming the transaction, information indicating that payment was received for the transaction from the transaction card and/or the transaction account, information indicating that the payment was credited to the merchant account, and/or the like.

As shown in FIG. 2F, and by reference number 275, the vehicle device may receive, via the first network and from the merchant device, order confirmation information. In some implementations, the order confirmation information may include information indicating that payment was received for the order, an order identifier (e.g., an order number, an order code, and/or the like), a receipt for the goods and/or services, and/or the like. As further shown in FIG. 1F, the vehicle device may provide the order confirmation information for display to the user via a user interface. For example, the user interface may include information indicating that the order (e.g., for the burger, the fries, and the drink) will be ready, information indicating an order number (e.g., “9023456”) for the order, and/or the like.

As shown in FIG. 2G, and by reference numbers 280 and 285, the vehicle device may provide, via the first network, the order confirmation information to the merchant device so that the user may receive the goods (e.g., the burger, the fries, and the drink) from the merchant. In some implementations, the user may show the user interface with the order confirmation information to the merchant, and the merchant may provide the goods to the user based on viewing the order confirmation information. In some implementations, the order confirmation information may cause the merchant device to automatically provide goods and/or services to the vehicle device and/or to the user of the vehicle device.

In some implementations, the vehicle device may provide, to the merchant device, information identifying a make, model, year, color, and/or the like, of the vehicle associated with the vehicle device, identifying the user of the vehicle device (e.g., an image of the user), and/or the like. The merchant device may utilize such information to automatically deliver the goods to the vehicle. For example, the merchant device may dispatch a drone, a robot, and/or the like to identify the vehicle and/or the user, and deliver the goods to the vehicle and/or the user. In some implementations, the vehicle device may provide, to the merchant device, location information associated with the vehicle device, and the drone, the robot, and/or the like, may utilize the location information to deliver the goods to the vehicle and/or the user.

In this way, several different stages of the process for securely conducting a transaction with a device integrated with a vehicle are automated, which may remove human subjectivity and waste from the process, and which may improve speed and efficiency of the process and conserve computing resources (e.g., processing resources, memory resources, and/or the like). Furthermore, implementations described herein use a rigorous, computerized process to perform tasks or roles that were not previously performed or were previously performed using subjective human intuition or input. For example, currently there does not exist a technique to securely conduct a transaction with a vehicle-integrated device. Finally, automating the process for securely conducting a transaction with a vehicle-integrated device conserves computing resources (e.g., processing resources, memory resources, and/or the like) that would otherwise be wasted in attempting to securely conduct a transaction with a vehicle-integrated device.

As indicated above, FIGS. 2A-2G are provided merely as examples. Other examples are possible and may differ from what was described with regard to FIGS. 2A-2G.

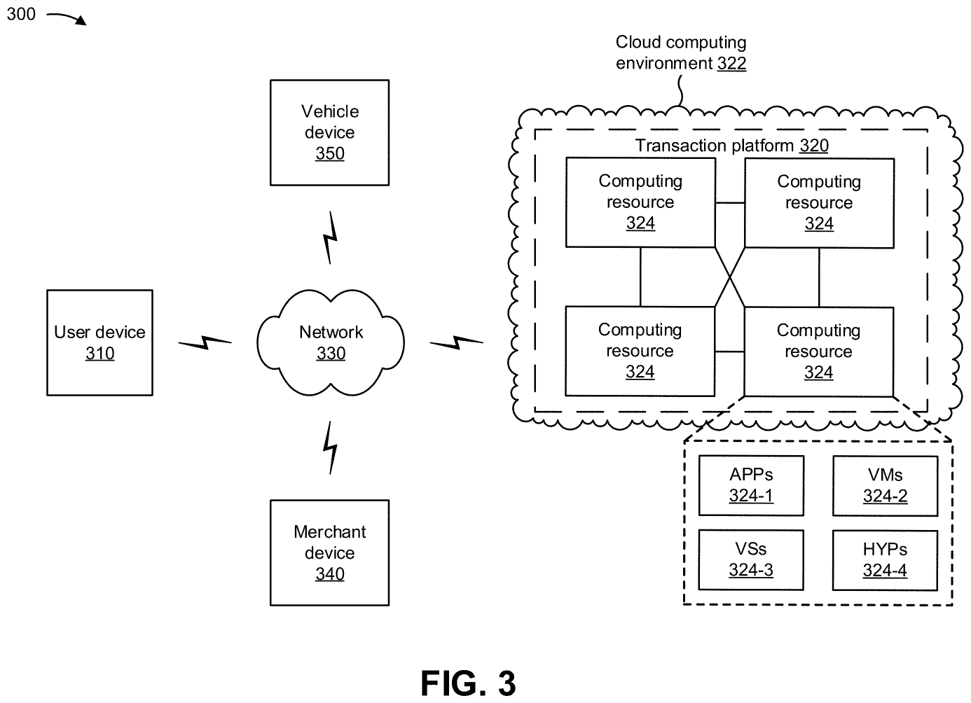

FIG. 3 is a diagram of an example environment 300 in which systems and/or methods, described herein, may be implemented. As shown in FIG. 3, environment 300 may include a user device 310, a transaction platform 320, a network 330, a merchant device 340, and a vehicle device 350. Devices of environment 300 may interconnect via wired connections, wireless connections, or a combination of wired and wireless connections.

User device 310 includes one or more devices capable of receiving, generating, storing, processing, and/or providing information, such as information described herein. For example, user device 310 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 310 may include an on-board vehicle system associated with a vehicle. In some implementations, one or more user devices 310 may be linked with a vehicle (e.g., via vehicle identification number, an on-board vehicle system, and/or the like) so that users in the vehicle may interact with a merchant, via specific user devices 310, to order and pay for goods.

In some implementations, user device 310 may receive information from and/or transmit information to transaction platform 320, merchant device 340, and/or vehicle device 350.

Transaction platform 320 includes one or more devices that validate and/or confirm transactions associated with user device 310, merchant device 340, and/or vehicle device 350. In some implementations, transaction platform 320 may be designed to be modular such that certain software components may be swapped in or out depending on a particular need. As such, transaction platform 320 may be easily and/or quickly reconfigured for different uses. In some implementations, transaction platform 320 may receive information from and/or transmit information to one or more user devices 310, merchant devices 340, and/or vehicle devices 350.

In some implementations, as shown, transaction platform 320 may be hosted in a cloud computing environment 322. Notably, while implementations described herein describe transaction platform 320 as being hosted in cloud computing environment 322, in some implementations, transaction platform 320 may not be cloud-based (i.e., may be implemented outside of a cloud computing environment) or may be partially cloud-based.

Cloud computing environment 322 includes an environment that hosts transaction platform 320. Cloud computing environment 322 may provide computation, software, data access, storage, etc. services that do not require end-user knowledge of a physical location and configuration of system(s) and/or device(s) that hosts transaction platform 320. As shown, cloud computing environment 322 may include a group of computing resources 324 (referred to collectively as “computing resources 324” and individually as “computing resource 324”).

Computing resource 324 includes one or more personal computers, workstation computers, server devices, or other types of computation and/or communication devices. In some implementations, computing resource 324 may host transaction platform 320. The cloud resources may include compute instances executing in computing resource 324, storage devices provided in computing resource 324, data transfer devices provided by computing resource 324, etc. In some implementations, computing resource 324 may communicate with other computing resources 324 via wired connections, wireless connections, or a combination of wired and wireless connections.

As further shown in FIG. 3, computing resource 324 includes a group of cloud resources, such as one or more applications (“APPs”) 324-1, one or more virtual machines (“VMs”) 324-2, virtualized storage (“VSs”) 324-3, one or more hypervisors (“HYPs”) 324-4, and/or the like.

Application 324-1 includes one or more software applications that may be provided to or accessed by user device 310, merchant device 340, and/or vehicle device 350. Application 324-1 may eliminate a need to install and execute the software applications on user device 310, merchant device 340, and/or vehicle device 350. For example, application 324-1 may include software associated with transaction platform 320 and/or any other software capable of being provided via cloud computing environment 322. In some implementations, one application 324-1 may send/receive information to/from one or more other applications 324-1, via virtual machine 324-2.

Virtual machine 324-2 includes a software implementation of a machine (e.g., a computer) that executes programs like a physical machine. Virtual machine 324-2 may be either a system virtual machine or a process virtual machine, depending upon use and degree of correspondence to any real machine by virtual machine 324-2. A system virtual machine may provide a complete system platform that supports execution of a complete operating system (“OS”). A process virtual machine may execute a single program, and may support a single process. In some implementations, virtual machine 324-2 may execute on behalf of a user (e.g., a user of user device 310, merchant device 340, and/or vehicle device 350, or an operator of transaction platform 320), and may manage infrastructure of cloud computing environment 322, such as data management, synchronization, or long-duration data transfers.

Virtualized storage 324-3 includes one or more storage systems and/or one or more devices that use virtualization techniques within the storage systems or devices of computing resource 324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 324-4 may provide hardware virtualization techniques that allow multiple operating systems (e.g., “guest operating systems”) to execute concurrently on a host computer, such as computing resource 324. Hypervisor 324-4 may present a virtual operating platform to the guest operating systems, and may manage the execution of the guest operating systems. Multiple instances of a variety of operating systems may share virtualized hardware resources.

Network 330 includes one or more wired and/or wireless networks. For example, network 330 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Merchant device 340 includes a device that conducts and completes a transaction at a time and place of the transaction. For example, merchant device 340 may include a point-of-sale (PoS) device, a mobile phone, a laptop computer, a tablet computer, a desktop computer, a handheld computer, a wearable communication device, or a similar type of device. Merchant device 340 may calculate an amount owed by a customer, may indicate that amount, may prepare an invoice for the customer, and may indicate options for the customer to make payment. Merchant device 340 may be point at which a customer makes a payment to a merchant in exchange for goods or after provision of a service. After receiving payment, merchant device 340 may issue a printed or an electronic receipt for the transaction.

Vehicle device 350 includes one or more devices capable of receiving, generating, storing, processing, and/or providing information, such as information described herein. For example, vehicle device 350 may include a device integrated within a vehicle, such as an in-vehicle infotainment (IVI) system, an in-car entertainment (ICE) system, a telematics device, a Global Positioning System (GPS) device, or a similar type of device. In some implementations, vehicle device 350 may receive information from and/or transmit information to user device 310, transaction platform 320, and/or merchant device 340.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

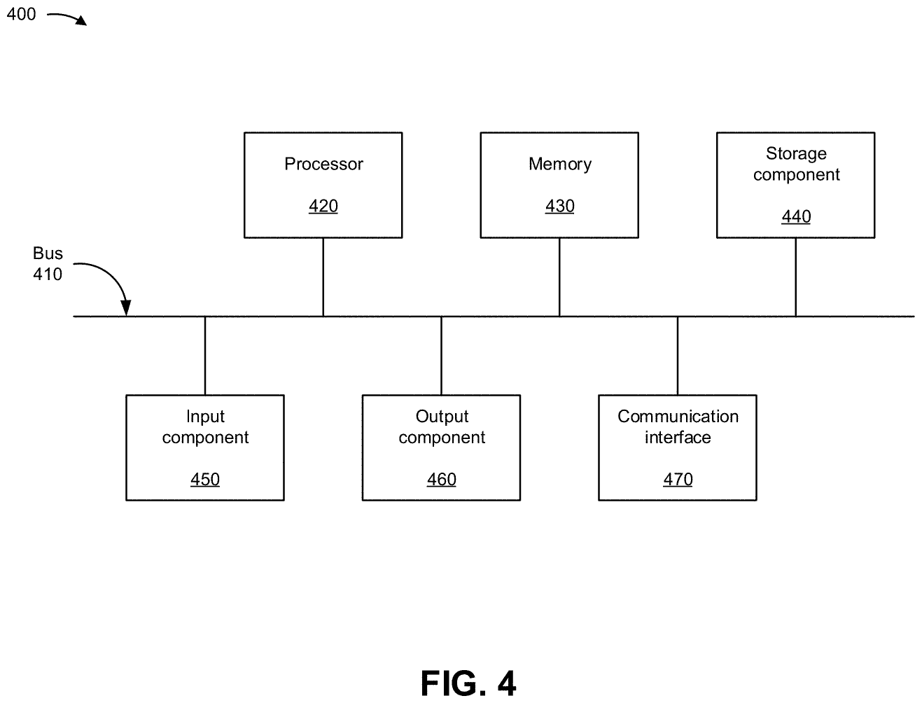

FIG. 4 is a diagram of example components of a device 400. Device 400 may correspond to user device 310, transaction platform 320, computing resource 324, merchant device 340, and/or vehicle device 350. In some implementations, user device 310, transaction platform 320, computing resource 324, merchant device 340, and/or vehicle device 350 may include one or more devices 400 and/or one or more components of device 400. As shown in FIG. 4, device 400 may include a bus 410, a processor 420, a memory 430, a storage component 440, an input component 450, an output component 460, and a communication interface 470.

Bus 410 includes a component that permits communication among the components of device 400. Processor 420 is implemented in hardware, firmware, or a combination of hardware and software. Processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 includes a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from device 400 (e.g., a display, a speaker, and/or one or more light-emitting diodes (LEDs)).

Communication interface 470 includes a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, and/or the like.

Device 400 may perform one or more processes described herein. Device 400 may perform these processes based on processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

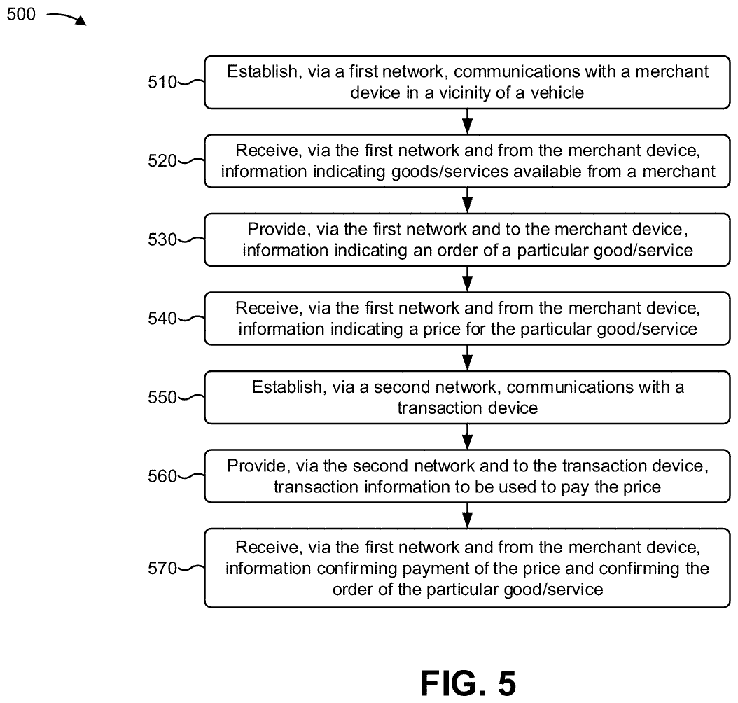

FIG. 5 is a flow chart of an example process 500 for securely conducting a transaction with a user device provided in a vehicle. In some implementations, one or more process blocks of FIG. 5 may be performed by a user device (e.g., user device 310). In some implementations, one or more process blocks of FIG. 5 may be performed by another device or a group of devices separate from or including user device 310, such as transaction platform 320 and/or merchant device 340.

As shown in FIG. 5, process 500 may include establishing, via a first network, communications with a merchant device in a vicinity of a vehicle (block 510). For example, the user device (e.g., using computing resource 324, processor 420, memory 430, communication interface 470, and/or the like) may establish, via a first network, communications with a merchant device in a vicinity of a vehicle, as described above in connection with FIGS. 1A-3.

As further shown in FIG. 5, process 500 may include receiving, via the first network and from the merchant device, information indicating goods or services available from a merchant (block 520). For example, the user device (e.g., using computing resource 324, processor 420, communication interface 470, and/or the like) may receive, via the first network and from the merchant device, information indicating goods or services available from a merchant, as described above in connection with FIGS. 1A-3.

As further shown in FIG. 5, process 500 may include providing, via the first network and to the merchant device, information indicating an order of a particular good or service (block 530). For example, the user device (e.g., using computing resource 324, processor 420, storage component 440, communication interface 470, and/or the like) may provide, via the first network and to the merchant device, information indicating an order of a particular good or service, as described above in connection with FIGS. 1A-3.

As further shown in FIG. 5, process 500 may include receiving, via the first network and from the merchant device, information indicating a price for the particular good or service (block 540). For example, the user device (e.g., using computing resource 324, processor 420, communication interface 470, and/or the like) may receive, via the first network and from the merchant device, information indicating a price for the particular good or service, as described above in connection with FIGS. 1A-3.

As further shown in FIG. 5, process 500 may include establishing, via a second network, communications with a transaction device (block 550). For example, the user device (e.g., using computing resource 324, processor 420, memory 430, communication interface 470, and/or the like) may establish, via a second network, communications with a transaction device, as described above in connection with FIGS. 1A-3.

As further shown in FIG. 5, process 500 may include providing, via the second network and to the transaction device, transaction information to be used to pay the price (block 560). For example, the user device (e.g., using computing resource 324, processor 420, storage component 440, communication interface 470, and/or the like) may provide, via the second network and to the transaction device, transaction information to be used to pay the price, as described above in connection with FIGS. 1A-3.

As further shown in FIG. 5, process 500 may include receiving, via the first network and from the merchant device, information confirming payment of the price and confirming the order of the particular good or service (block 570). For example, the user device (e.g., using computing resource 324, processor 420, communication interface 470, and/or the like) may receive, via the first network and from the merchant device, information confirming payment of the price and confirming the order of the particular good or service, as described above in connection with FIGS. 1A-3.

Process 500 may include additional implementations, such as any single implementation or any combination of implementations described below and/or described with regard to any other process described herein.

In some implementations, the user device may receive a signal identifying the first network and the merchant device, and may establish, via the first network, the communications with the merchant device based on receiving the signal identifying the first network. In some implementations, the first network may be considered an unsecure network, which generally may be less secure than a second network. In some implementations, the second network may include a secure network that securely provides the transaction information to the transaction device. In some implementations, the user device may include a mobile device associated with a driver or a passenger in the vehicle. In some implementations, the payment information may include a secure link to the transaction device, and the user device may establish, via the second network, the communications with the transaction device based on the secure link to the transaction device.

In some implementations, the first network may include a Bluetooth technology-based network, a Wi-Fi technology-based network, an infrared technology-based network, a near field communication (NFC) technology-based network, an ultraband technology-based network, and/or a Zigbee technology-based network, and the second network may include a cellular network, a public land mobile network (PLMN), a local area network (LAN), a wide area network (WAN), a metropolitan area network (MAN), and/or a wireless network. In some implementations, the user device may receive, via the second network and from the transaction device, the information confirming the payment of the price for the particular good or service.

In some implementations, the user device may receive, via the first network and from the merchant device, the information confirming the payment of the price for the particular item. In some implementations, the user device may receive a signal identifying the unsecure network and the merchant device, and may establish, via the first network, the communications with the merchant device based on receiving the signal identifying the first network. In some implementations, the payment information may include a secure link to the transaction device, and the user device may establish, via a more secure second network, the communications with the transaction device based on the secure link to the transaction device. In some implementations, the items may include one or more goods or one or more services available from the merchant. In some implementations, the first network may include an unsecure network, and the second network may include a secure network. In some implementations, the user device may cause the merchant device to provide the particular good or service to a user of the user device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

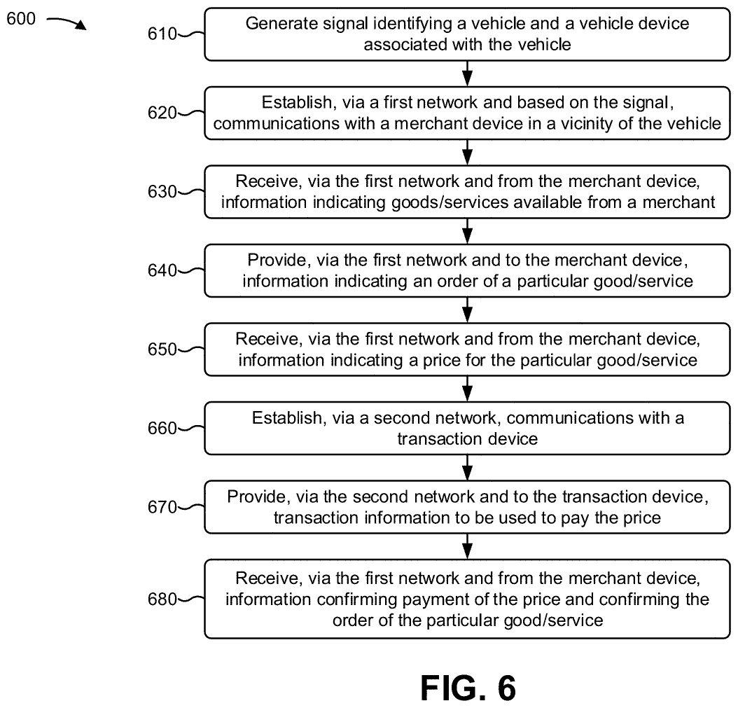

FIG. 6 is a flow chart of an example process 600 for securely conducting a transaction with a device integrated within a vehicle. In some implementations, one or more process blocks of FIG. 6 may be performed by a vehicle device (e.g., vehicle device 350). In some implementations, one or more process blocks of FIG. 6 may be performed by another device or a group of devices separate from or including vehicle device 350, such as transaction platform 320, merchant device 340, and/or user device 310.

As shown in FIG. 6, process 600 may include generating a signal identifying a vehicle and a vehicle device associated with the vehicle (block 610). For example, the vehicle device (e.g., using computing resource 324, processor 420, memory 430, communication interface 470, and/or the like) may generate a signal identifying the vehicle device and a vehicle associated with the vehicle device, as described above in connection with FIGS. 1A-3.

As further shown in FIG. 6, process 600 may include establishing, via a first network and based on the signal, communications with a merchant device in a vicinity of the vehicle (block 620). For example, the vehicle device (e.g., using computing resource 324, processor 420, memory 430, communication interface 470, and/or the like) may establish, via a first network and based on the signal, communications with a merchant device in a vicinity of the vehicle, as described above in connection with FIGS. 1A-3.

As further shown in FIG. 6, process 600 may include receiving, via the first network and from the merchant device, information indicating goods or services available from a merchant (block 630). For example, the vehicle device (e.g., using computing resource 324, processor 420, communication interface 470, and/or the like) may receive, via the first network and from the merchant device, information indicating goods or services available from a merchant, as described above in connection with FIGS. 1A-3.

As further shown in FIG. 6, process 600 may include providing, via the first network and to the merchant device, information indicating an order of a particular good or service (block 640). For example, the vehicle device (e.g., using computing resource 324, processor 420, storage component 440, communication interface 470, and/or the like) may provide, via the first network and to the merchant device, information indicating an order of a particular good or service, as described above in connection with FIGS. 1A-3.

As further shown in FIG. 6, process 600 may include receiving, via the first network and from the merchant device, information indicating a price for the particular good or service (block 650). For example, the vehicle device (e.g., using computing resource 324, processor 420, communication interface 470, and/or the like) may receive, via the first network and from the merchant device, information indicating a price for the particular good or service, as described above in connection with FIGS. 1A-3.

As further shown in FIG. 6, process 600 may include establishing, via a second network, communications with a transaction device (block 660). For example, the vehicle device (e.g., using computing resource 324, processor 420, memory 430, communication interface 470, and/or the like) may establish, via a second network, communications with a transaction device, as described above in connection with FIGS. 1A-3.

As further shown in FIG. 6, process 600 may include providing, via the second network and to the transaction device, transaction information to be used to pay the price (block 670). For example, the vehicle device (e.g., using computing resource 324, processor 420, storage component 440, communication interface 470, and/or the like) may provide, via the second network and to the transaction device, transaction information to be used to pay the price, as described above in connection with FIGS. 1A-3.

As further shown in FIG. 6, process 600 may include receiving, via the first network and from the merchant device, information confirming payment of the price and confirming the order of the particular good or service (block 680). For example, the vehicle device (e.g., using computing resource 324, processor 420, communication interface 470, and/or the like) may receive, via the first network and from the merchant device, information confirming payment of the price and confirming the order of the particular good or service, as described above in connection with FIGS. 1A-3.

Process 600 may include additional implementations, such as any single implementation or any combination of implementations described below and/or described with regard to any other process described herein.

In some implementations, the vehicle device may receive another signal identifying the first network and the merchant device, and may establish, via the first network and based on the signal, the communications with the merchant device based on receiving the other signal identifying the first network. In some implementations, the second network may include a secure network that securely provides the transaction information to the transaction device. In some implementations, the properties of the vehicle, identified in the vehicle information, may include information identifying a make of the vehicle, a model of the vehicle, a color of the vehicle, and/or a license plate number of the vehicle.

In some implementations, the payment information may include a secure link to the transaction device, and the vehicle device may establish, via the second network, the communications with the transaction device based on the secure link to the transaction device. In some implementations, the first network may include a Bluetooth technology-based network, an infrared technology-based network, a near field communication (NFC) technology-based network, an ultraband technology-based network, and/or a Zigbee technology-based network. In some implementations, the second network may include a cellular network, a public land mobile network (PLMN), a local area network (LAN), a wide area network (WAN), a metropolitan area network (MAN), and/or a wireless network. In some implementations, the vehicle device may receive, via the second network and from the transaction device, the information confirming the payment of the price for the particular good or service.

Some implementations described herein enable a user device, provided in a vehicle, to securely conduct a transaction. For example, the user device may establish, via an unsecure network, communications with a merchant device in a vicinity of the vehicle, and may receive, via the unsecure network and from the merchant device, information indicating goods and/or services available from a merchant associated with the merchant device. The user device may provide, via the unsecure network and to the merchant device, information indicating an order of a particular good or service, and may receive, via the unsecure network and from the merchant device, information indicating a price for the particular good or service. The user device may establish, via a secure network, communications with a transaction device, and may provide, via the secure network and to the transaction device, transaction information to be used to pay the price for the particular good or service. The user device may receive, via the unsecure network and from the merchant device, information confirming payment of the price and confirming the order of the particular good or service.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
one or more memories; and
one or more processors configured to:
generate a signal identifying the device and a vehicle,
the device being integrated within the vehicle,
the device being one of:
an in-vehicle infotainment system,
an in-car entertainment system,
an in-vehicle telematics device, or
an in-vehicle global positioning system (GPS) device;
establish, via a first network and based on the signal, communications with a merchant device in a vicinity of the vehicle,
the first network including an unsecure network;
provide, via the first network and to the merchant device, vehicle information identifying properties of the vehicle for identification by a merchant associated with the merchant device,
the vehicle information including at least one of:
a color of the vehicle,
a make of the vehicle,
a model of the vehicle, or
a license associated with the vehicle;
receive, based on the vehicle information, via the first network, and from the merchant device, merchant information indicating goods or services available from the merchant associated with the merchant device,
the merchant device to use the first network to identify one or more other user devices provided in the vehicle, and
the merchant device being able to distinguish between the device and the one or more other user devices based upon the signal identifying the device and the vehicle;
provide, via the first network and to the merchant device, order information indicating an order of a particular good or service of the goods or services;
receive, via the first network and from the merchant device, payment information indicating a price for the particular good or service;
establish, via a second network that is a secure network, communications with a transaction device;
provide, via the second network and to the transaction device, transaction information to be used to pay the price for the particular good or service; and
receive, based on the vehicle information, via the first network, and from the merchant device:
information confirming payment of the price for the particular good or service, and
information confirming the order of the particular good or service.

2. The device of claim 1, wherein the one or more processors are further configured to:
receive another signal identifying the first network and the merchant device; and
wherein the one or more processors, when establishing, via the first network and based on the signal, the communications with the merchant device, are configured to:
establish, via the first network and based on the signal, the communications with the merchant device based on receiving the other signal identifying the first network.

3. The device of claim 1, wherein the second network includes a secure network that securely provides the transaction information to the transaction device.

4. (canceled)

5. The device of claim 1, wherein the payment information includes a secure link to the transaction device, and
wherein the one or more processors, when establishing, via the second network, the communications with the transaction device, are configured to:
establish, via the second network, the communications with the transaction device based on the secure link to the transaction device.

6. The device of claim 1, wherein:
the first network includes one or more of:
a Bluetooth technology-based network,
an infrared technology-based network,
a near field communication (NFC) technology-based network,
an ultraband technology-based network, or
a Zigbee technology-based network; and
the second network includes or more of:
a cellular network,
a public land mobile network (PLMN),
a local area network (LAN),
a wide area network (WAN),
a metropolitan area network (MAN), or
a wireless network.

7. The device of claim 1, wherein the one or more processors are further configured to:
receive, via the second network and from the transaction device, the information confirming the payment of the price for the particular good or service.

8. A non-transitory computer-readable medium storing instructions, the instructions comprising:
one or more instructions that, when executed by one or more processors of a device, cause the one or more processors to:
generate a signal identifying the device and a vehicle,
the device being integrated within the vehicle,
the device being one of:
an in-vehicle infotainment system,
an in-car entertainment system,
an in-vehicle telematics device, or
an in-vehicle global positioning system (GPS) device;
establish, via an unsecure network and based on the signal, communications with a merchant device in a vicinity of the vehicle;
provide, via the unsecure network and to the merchant device, vehicle information identifying properties of the vehicle for identification by a merchant associated with the merchant device,
the vehicle information including at least one of:
a color of the vehicle,
a make of the vehicle,
a model of the vehicle, or
a license associated with the vehicle;
receive, based on the vehicle information, via the unsecure network, and from the merchant device, merchant information indicating items available from the merchant associated with the merchant device,
the merchant device to use the unsecure network to identify one or more other user devices provided in the vehicle, and
the merchant device being able to distinguish between the device and the one or more other user devices based upon the signal identifying the device and the vehicle;
provide, via the unsecure network and to the merchant device, order information indicating an order of a particular item of the items;
receive, via the unsecure network and from the merchant device, payment information indicating a price for the particular item;
establish, via a secure network, secure communications with a transaction device;
provide, via the secure network and to the transaction device, transaction information to be used to pay the price for the particular good or service,
the transaction information including information identifying a transaction account associated with a user of the device;
receive, via the secure network and from the transaction device, information confirming payment of the price for the particular item; and
receive, based on the vehicle information, via the unsecure network, and from the merchant device, information confirming the order of the particular item.

9. The non-transitory computer-readable medium of claim 8, wherein the instructions further comprise:
one or more instructions that, when executed by the one or more processors, cause the one or more processors to:
receive, based on the vehicle information, via the unsecure network, and from the merchant device, the information confirming the payment of the price for the particular item.

10. The non-transitory computer-readable medium of claim 8, wherein the instructions further comprise:
one or more instructions that, when executed by the one or more processors, cause the one or more processors to:
receive another signal identifying the unsecure network and the merchant device; and
wherein the one or more instructions, that cause the one or more processors to establish, via the unsecure network and based on the signal, the communications with the merchant device, cause the one or more processors to:
establish, via the unsecure network and based on the signal, the communications with the merchant device based on receiving the other signal identifying the unsecure network.

11. (canceled)

12. The non-transitory computer-readable medium of claim 8, wherein the payment information includes a secure link to the transaction device, and
wherein the one or more instructions, that cause the one or more processors to establish, via the secure network, the communications with the transaction device, cause the one or more processors to:
establish, via the secure network, the communications with the transaction device based on the secure link to the transaction device.

13. The non-transitory computer-readable medium of claim 8, wherein:
the unsecure network includes one or more of:
a Bluetooth technology-based network,
an infrared technology-based network,
a near field communication (NFC) technology-based network,
an ultraband technology-based network, or
a Zigbee technology-based network; and
the secure network includes or more of:
a cellular network,
a public land mobile network (PLMN),
a local area network (LAN),
a wide area network (WAN),
a metropolitan area network (MAN), or
a wireless network.

14. The non-transitory computer-readable medium of claim 8, wherein the items include one or more goods or one or more services available from the merchant.

15. A method, comprising:
generating, by a device, a signal identifying the device and a vehicle,
the device being integrated within the vehicle,
the device being one of:
an in-vehicle infotainment system,
an in-car entertainment system,
an in-vehicle telematics device, or
an in-vehicle global positioning system (GPS) device;
establishing, by the device, based on the signal, and via a first network, communications with a merchant device in a vicinity of the vehicle,
the first network including an unsecure network;
providing, by the device, via the first network, and to the merchant device, vehicle information identifying properties of the vehicle for identification by a merchant associated with the merchant device,
the vehicle information including at least one of:
a color of the vehicle,
a make of the vehicle,
a model of the vehicle, or
a license associated with the vehicle;
receiving, by the device, based on the vehicle information, via the first network, and from the merchant device, merchant information indicating goods or services available from the merchant associated with the merchant device,
the merchant device to use the first network to identify one or more other user devices provided in the vehicle, and
the merchant device being able to distinguish between the device and the one or more other user devices based upon the signal identifying the device and the vehicle;
providing, by the device, via the first network, and to the merchant device, order information indicating an order of a particular good or service of the goods or services;
receiving, by the device, based on the vehicle information, via the first network, and from the merchant device, payment information indicating a price for the particular good or service;
establishing, by the device and via a second network that is a secure network, communications with a transaction device;
providing, by the device, via the second network, and to the transaction device, transaction information to be used to pay the price for the particular good or service;
receiving, by the device, via the second network, and from the transaction device, information confirming payment of the price for the particular good or service; and
receiving, by the device, based on the vehicle information, via the first network, and from the merchant device, information confirming the order of the particular good or service.

16. The method of claim 15, wherein:
the first network includes an unsecure network, and
the second network includes a secure network.

17. (canceled)

18. The method of claim 15, wherein the payment information includes a secure link to the transaction device, and
establishing, via the second network, the communications with the transaction device comprises:
establishing, via the second network, the communications with the transaction device based on the secure link to the transaction device.

19. The method of claim 15, further comprising:
receiving, based on the vehicle information, via the first network, and from the merchant device, the information confirming the payment of the price for the particular good or service.

20. The method of claim 15, further comprising:
causing the merchant device to provide the particular good or service to a driver of the vehicle.

21. The device of claim 1, wherein the one or more processors are further configured to:
receive, from the merchant device, validation of the transaction information to be used to pay for the particular good or service.

22. The non-transitory computer-readable medium of claim 8, wherein one or more instructions further cause the one or more processors to:
receive, from the merchant device, validation of the transaction information to be used to pay for the particular good or service.

23. The method of claim 15, further comprising:
receiving, from the merchant device, validation of the transaction information to be used to pay for the particular good or service.
